(19) United States
(12) Patent Application Publication
(10) Pub. No.: US 2005/0078810 A1
(43) Pub. Date: Apr. 14, 2005

(54) Automatic telephone call holding system

(75) Inventors: Dennis Cromwell, Sioux Falls, SD (US); Alan Hoogestraat, Sioux Falls, SD (US)

Correspondence Address: OPPENHEIMER WOLFF & DONNELLY LLP, 45 SOUTH SEVENTH STREET, SUITE 3300, MINNEAPOLIS, MN, 55402, US

(73) Assignee: Corvex, Inx., Sioux Falls, SD (US)

(21) Appl. No.: 10/961,120

(22) Filed: Oct. 8, 2004

Related U.S. Application Data
(60) Provisional application No. 60/510,164, filed on Oct. 10, 2003.

(51) Int. Cl. H04M 3/00

(52) U.S. Cl. 379/188

(57) ABSTRACT

An economic alternative to expensive answering services intercepts incoming phone calls after a predetermined number of rings and plays a prerecorded greeting to the incoming caller. After the greeting the device places the caller on hold. One embodiment gives the caller the choice to hold or to be connected to voice mail. If the caller chooses to hold, the device plays music from an external source until the call is answered. An indicator light illuminates signifying that a caller is on hold. An audible tone also plays intermittently alerting the recipient of the phone call that a caller is holding. The device has the capacity to handle calls to multiple phones from multiple incoming telephone lines.

### PRIORITY CLAIM

This application claims priority to provisional application Ser. No. 60/510,164 entitled AUTOMATIC TELEPHONE CALL HOLDING SYSTEM, filed on Oct. 10, 2003.

### BACKGROUND OF THE INVENTION

The present invention relates to a phone call handling system for use in a small office or home office setting. More specifically, the present invention provides an inexpensive solution to the small business owner which allows incoming calls to be handled in a professional manner. The present system provides the ability to receive phone calls, play a short message, and place these calls on hold, thus providing the opportunity for these calls to be handled a short time later.

In many small or home offices, cost and space considerations cause several limitations. For example, it is often inefficient or impractical to hire a receptionist or assistant to handle incoming phone calls. Additionally, expensive answering systems are also impractical, most often being cost prohibitive. Consequently, these offices are often equipped with a simple answering machine to handle calls.

Despite the limitations mentioned above, there is a continuing need for any incoming phone calls to be handled in a professional and responsible manner. As is well known, the customer relationship, and the way customer phone calls are handled, can reflect very largely on a business owner's reputation. Having phone calls go unanswered is an undesirable solution. Likewise, impersonal answering machines are often disfavored because they lack any human interface or interaction. That said, it is also impractical for the small business owner to immediately answer or address every phone call that comes in at any given time. Consequently, an alternative solution is very desirable.

In addition to the concerns mentioned above regarding unanswered calls, it may also be desirable to play a uniform greeting to incoming callers before a phone is answered. For example, the business name could be recited along with a uniform greeting to customers. This would be followed by an indication that calls will be addressed shortly. As can be imagined, the standard answering machine cannot accomplish this function, and more elaborate phone systems are again cost prohibitive.

### BRIEF SUMMARY OF THE INVENTION

The present invention provides a system which will answer an incoming phone call, play a short message or greeting, and then place that call on hold. When a call is on hold, an indicator light will indicate this fact. The business owner, small office employee, or home office worker has the opportunity to finish whatever business they are presently undertaking, and attend to the pending call. Further, when on hold the system will provide periodic reminders (i.e., beeps or tones), which will alert the business owner to the fact that a call is holding.

While on hold, the present system has the ability to play music or some other audio message for the holding caller. This audio may including promotional information regarding the company, or any other desired messages.

The call handling system of the present invention has the ability to work with a single phone or multiple phones as needed. In this way, multiple phone lines can receive similar treatment.

### BRIEF DESCRIPTION OF THE DRAWINGS

Further objects and advantages of the present invention can be seen by reading the following detailed description, in conjunction with the drawings in which:

FIG. 1 is a top view of the phone call handling system;

FIG. 2 is a rear view of the phone call handling system illustrating the connection ports;

FIG. 3 is a schematic drawing illustrating appropriate connection using a standard one or two line phone;

FIG. 4 is a schematic illustration showing a connection to a telephone system;

FIG. 5 is a block diagram illustrating the components making up the phone call handling system; and

FIG. 6 is a flow chart illustrating the call handling process utilized by the present invention.

### DESCRIPTION OF THE PREFERRED EMBODIMENT

The phone call handling system of the present invention is an automatic device designed for Small Office/Home office (SOHO) use. It is designed to provide courteous, professional service to callers when phones cannot be answered immediately. The phone call handling system is configured to answer ringing phones, play a short greeting, and then place the call on hold. This device is equipped with a music-on-hold interface so that callers who are placed on hold may listen to music from an external source (such as a CD player) until a live person is able to pick up the call.

The phone call handling system of the preferred embodiment will answer either one (1) or two (2) analog telephone lines. These lines within the present phone call answering system operate independently of each other. Naturally, those skilled in the art will recognize that the system could easily be modified to handle additional lines. Each line can be selected to answer on a pre-set number of rings (1 to 8 rings). Users can also record their own digitally stored greeting of up to one (1) minute in length on each line. Again, modifications could be made so this recording time is easily increased to any appropriate period.

A flashing “On-Hold” light built into each line of the phone call handling system will alert you that calls are holding. Also, every twenty seconds a gentle tone will sound to remind you that you have calls waiting to be answered.

The phone call handling system will keep your caller on hold until one of the following events occur:
(1) You pick up the line and answer the call. When you pick up the line the phone call handling system will automatically drop the music from the connection and you will be connected to the caller immediately.
(2) The caller decides not to wait and hangs up the phone. When this occurs the phone call handling system will detect that your caller has hung up (this can take 4-6 seconds after hang up to occur) and will automatically drop the music and free up your line for the next call.

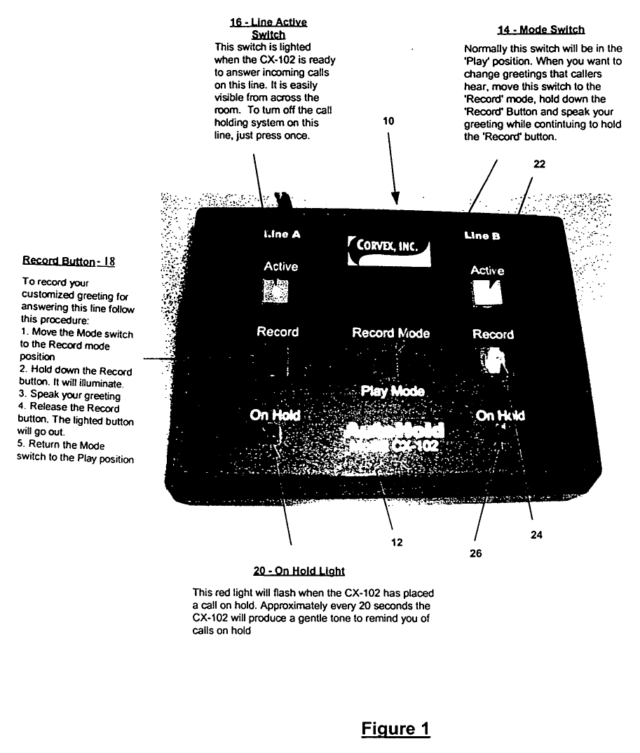

Referring now to the figures, FIG. 1 illustrates a top view of the phone call handling system 10. As can seen from this drawing, the phone call handling system 10 includes a housing 12, which contains all necessary connections and electronics. On the front panel of housing 12, there are the following control switches and indicators: a mode switch 14, a line A active switch 16, a line A record button 18, a line A hold indicator 20, a line B active switch 22, a line B record button 24, and a line B hold indicator 26. As can be anticipated, mode switch 14 provides the ability to record a greeting or outgoing message to be played when the phone line is answered. Once in record mode, line A record button 18 and line B record button 24 are both actuated to record the respective greetings on the particular lines.

Both line A active switch 16 and line B active switch 22 activates the phone call handling system 10. Lastly, line A hold indicator 20 and line B hold indicator 26 both provide a visual indication to the office resident that the particular phone lines are “on hold”.

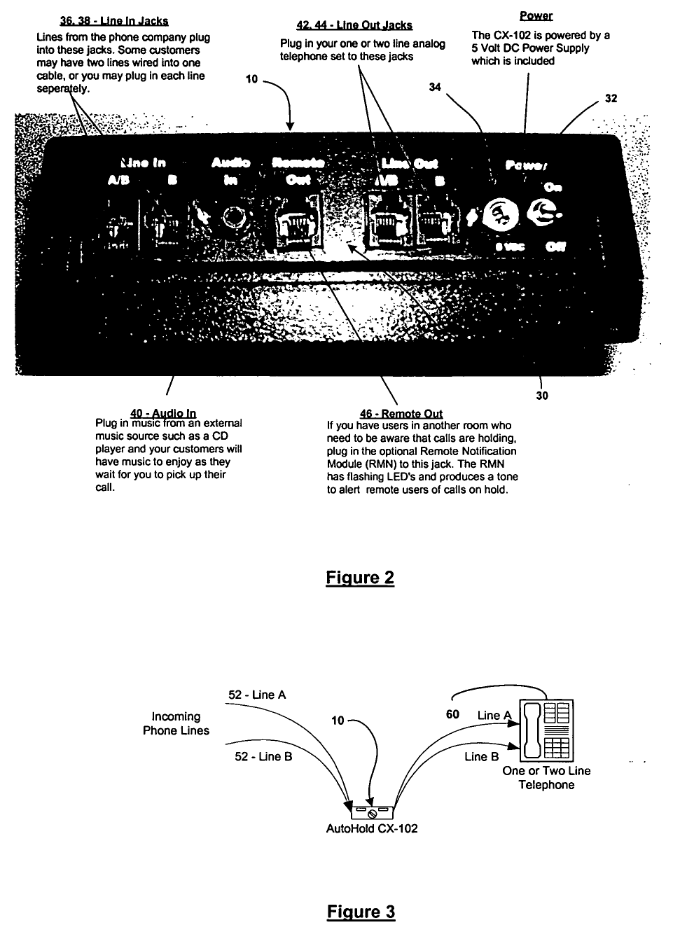

Referring now to FIG. 2, there is shown the back panel 30 of phone call handling system 10. As can be seen in FIG. 2, positioned on back panel 30 are a power switch 32 and a power connection 34, a first line-in jack 36 and a second line-in jack 38, an audio input 40, a first line-out jack 42 and a second line-out jack 44, and a remote output 46. Based upon the names for each of these components, their operation or attachment should be self-explanatory.

Moving on now to FIG. 3, a schematic illustration showing appropriate connection of phone lines as shown. As can be seen, the incoming phone lines, line A 52 and line B 54 are both connected to the appropriate jack in phone call handling system 10. The lineout connections from phone call handling system 10 are then attached to either a one or two line telephone 60.

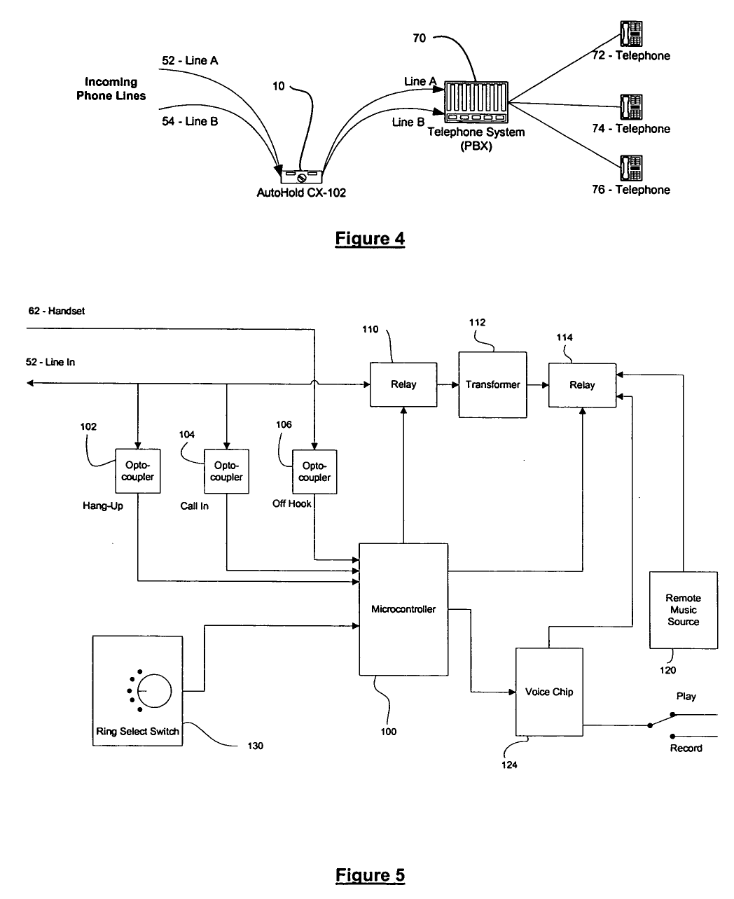

FIG. 4 illustrates a similar connection methodology, however, connected to a more complex phone system. Incoming line A 52 and incoming line B 54 are again connected to telephone call handling system 10. The outputs can easily be connected to telephone system 70. Based upon the configuration of telephone system 70, a first phone 72, second phone 74 and third phone 76 can easily be connected thereto. Using this connection methodology, enhanced flexibility and features can be utilized. Additionally, one or more of the devices 72, 74 and/or 76, may be telephone answering machines.

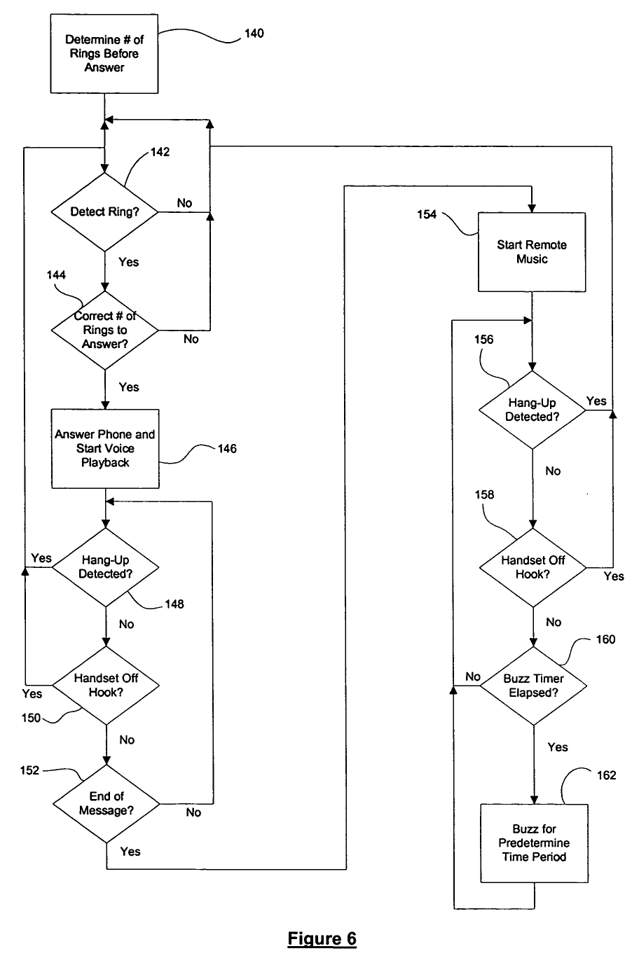

The internal circuitry of telephone handling system 10 can be further understood by referring to FIG. 5. As shown, FIG. 5 is a block diagram illustrating the components making up telephone handling system 10. At the heart of this telephone handling system 10 is micro-controller 100 which controls overall operation. Incoming line A 52 is attached to a number of components in order to provide various functions. More specifically, incoming line 52 is attached to a first opto coupler 102 and a second opto coupler 104. Second opto coupler 104 is configured to detect when an incoming phone call is received. Alternatively, first opto coupler 102 is connected to determine when the caller has disconnected or hung-up. Incoming line A 52 is similarly connected to a first relay 110.

In order to determine the status of the telephone itself (within the small office), the handset switch of that phone is connected to a third opto coupler 106.

As is also seen in FIG. 5, the output from first opto coupler 102, second opto coupler 104 and third opto coupler 106 are all connected to respective inputs of micro-controller 100. Consequently, micro-controller 100 is able to determine the status of these various signals. As will be described below, the operation of phone handling system 10 is then capable of responding to various actions.

Relay 110 has an input from micro-controller 100 and has its output connected to an isolation transformer 112. The output of isolation transformer 112 is then connected to a second relay 114, which also has a control input coming from micro-controller 100. Second relay 114 is a dual pole relay having an input from both a remote music source 120 and a voice chip 124.

Also connected to micro-controller 100 is a ring select switch 130 which is used to control when a phone handling system 10 will answer incoming calls. More specifically, ring select switch 130 determines how many rings occur before phone handling system 10 will answer the respective call.

Referring now to FIG. 6, there is a flow chart illustrating the operation of phone call handling system 10. This process begins at step 140 where the system determines how many rings should occur before the incoming call is answered. Referring to FIG. 5, this is done primarily by examining the status of ring select switch 130. Next, the process proceeds to step 142 and determines if a ring has been detected. If no, the system simply loops back and waits until this occurs. Once a ring has been detected, the system determines whether an appropriate number of rings have occurred. This occurs in step 144. Once a sufficient number of rings have occurred, the phone line is answered and the voice playback message is played at step 146. While this occurs, the system continuously analyzes whether the caller has hung up or whether the handset is still on the hook. These two steps occur at steps 148 and 150. If neither of these conditions change, the system simply continues playing until the end of the message at step 152. Once the end of the message is reached, the system begins playing background music at step 154. Again, while background music is being played, the system continuously analyzes whether the caller has hung up or the handset continues to be on hook. Further, the system includes an internal timer to determine how long the call has been holding. If the call is held beyond a desired time period, the system will then initiate a buzzer to indicate that the call is still waiting attention. This analysis and playing of the buzzer is illustrated in steps 160 and 162 of the flowchart shown on FIG. 6.

One embodiment includes a playing a voice message at 146 that gives the caller the option to leave a message. The caller can respond in the affirmative by pressing a button on his or her telephone. Doing so places the audio player or voice chip 124 in a temporary record mode whereby a voice mail message can be recorded.

In order to better understand the operation of the present invention, certain instructions related to the preferred embodiment are outlined below. More specifically, these instructions relate to the initial set-up, and recording of personal greetings.

Initial Setup
1. Insure that Power is off.
2. Turn the phone call handling system over and notice that there are two small dial switches recessed into the plastic case of your unit. They are labeled ‘Line A rings’ and ‘Line B rings’. These dials will allow you to adjust the number of rings before the phone call handling system answers the call automatically. Using a small screwdriver turn the white dot on each dial to the desired number of rings on each line.
3. Plug in your telephone line(s) to the “Line In” Jacks on the back of the phone call handling system.
4. If you have an external audio source such as a CD player or a radio you can plug it into the “Audio In” jack.
5. Plug your one or two line telephone into the “Line Out” jacks.
6. Attach the 5 VDC power cord and plug the adaptor into a 110V wall outlet.
7. Turn the power switch on
8. Activate either, or both, Line A and Line B by pressing the “Active” button on each line. The button should illuminate.
9. You will now need to record a personal greeting on either, or both, lines of the phone call handling system.

Recording Your Personal Greeting
a. Be sure the green ‘Active’ light is illuminated on the line you wish to record.
b. Move the “MODE” switch to the ‘Record Mode’ position.
c. Hold down the red ‘Record’ button on the line you wish to record and begin to speak your message. The microphone is located just below the “Record” button. You will see a small hole there. Your greeting on each line may be up to one minute in length.

Example: “Hello, thank you for calling XYZ Company. Please hold momentarily and our next available staff member will be glad to answer your call.”
d. Release the ‘Record’ button as soon as you have finished speaking your greeting.

When finished recording greetings, move the “Mode” switch to the ‘Play Mode’ position. The phone call handling system 10 is now ready to answer calls when individuals are unable.

It is contemplated that features disclosed in this application can be mixed and matched to suit particular circumstances. Various other modifications and changes will be apparent to those of ordinary skill in the art without departing from the spirit and scope of the present invention.

1. A telephone call holding system comprising:
a housing;
a circuit operably contained within the housing;
a line in jack accessible through the housing usable to connect the circuit to an outside phone line;
a line out jack accessible through the housing usable to connect the circuit to a telephone;
wherein the circuit comprises:
an audio device capable of playing a stored message and recording an incoming message;
a microcontroller programmed to:
intercept an incoming telephone call from a caller after a telephone operably connected to the line out jack has rung a predetermined number of times;
play a recorded message stored on the audio device greeting the caller and providing the caller a choice to hold or leave a message on the audio device;
either placing the caller on hold or recording a message from the caller on the audio device according to the choice made by the caller;
illuminate a hold indicator light indicating the caller is on hold if the caller chooses to hold.

2. The telephone call holding system of claim 1 further comprising an audio in jack usable to connect an audio signal from an audio source to the telephone via the circuit.

3. The telephone call holding system of claim 1 further comprising a remote jack usable to connect the circuit to a remote notification module.

4. The telephone call holding system of claim 1 further comprising a ring select switch operably connected to the circuit, having a plurality of positions, each position establishing the predetermined number of times the telephone must ring before the recorded message is played by the audio device greeting the caller.

5. The telephone call holding system of claim 11 wherein the line in jack is connected to the microcontroller via a first opto coupler and a second opto coupler, the first opto coupler configured to detect when the incoming call has disconnected, the second opto coupler configured to detect when the incoming phone call is received.

6. The telephone call holding system of claim 1 further comprising a second line in jack accessible through the housing usable to connect the circuit to a second outside phone line.

7. The telephone call holding system of claim 1 further comprising a second line out jack accessible through the housing usable to connect the circuit to a second telephone.

8. The telephone call holding system of claim 2 wherein the microcontroller is further programmed to play music received through the audio jack to the while the caller is on hold.

9. A telephone call holding system comprising:
means for intercepting an incoming telephone call from a caller;
means for playing a recorded greeting to the caller;
means for placing the caller on hold.

10. The telephone call holding system of claim 9 further comprising a means for notifying a user that a caller is on hold.

11. The telephone call holding system of claim 10 wherein the means for notifying a user that a caller is on hold comprises a hold indicator light.

12. The telephone call holding system of claim 10 wherein the means for notifying a user that a caller is on hold comprises a means for playing an audible tone.

13. The telephone call holding system of claim 10 wherein the means for notifying a user that a caller is on hold comprises a remote notification module.

14. The telephone call holding system of claim 9 further comprising a means for playing music to the caller while the caller is on hold.

15. The telephone call holding system of claim 13 wherein the means for playing music to the caller while the caller is on hold comprises a jack usable to connect the telephone call holding system to an external music source.

16. The telephone call holding system of claim 9 wherein the means for intercepting an incoming call from a caller comprises a means for selecting a desired number of rings before the call is intercepted.

17. The telephone call holding system of claim 9 further comprising:
means for providing the caller a choice to hold or leave a message;
means for receiving the choice made by the caller;
means for recording a message left by the caller.

18. A telephone call holding system comprising:
a housing;
a circuit operably contained within the housing;
a line in jack accessible through the housing usable to connect the circuit to an outside phone line;
a line out jack accessible through the housing usable to connect the circuit to a telephone;
wherein the circuit comprises:
an audio device capable of playing a stored message;
a microcontroller programmed to:
intercept an incoming telephone call from a caller after a telephone operably connected to the line out jack has rung a predetermined number of times;
play a recorded message stored on the audio device greeting the caller;
placing the caller on hold;
illuminate a hold indicator light indicating the caller is on hold.

19. The telephone call holding system of claim 18 further comprising an audio in jack usable to connect an audio signal from an audio source to the telephone via the circuit.

20. The telephone call holding system of claim 18 further comprising a remote jack usable to connect the circuit to a remote notification module.

21. The telephone call holding system of claim 18 further comprising a ring select switch operably connected to the circuit, having a plurality of positions, each position establishing the predetermined number of times the telephone must ring before the recorded message is played by the audio device greeting the caller.

22. The telephone call holding system of claim 18 wherein the line in jack is connected to the microcontroller via a first opto coupler and a second opto coupler, the first opto coupler configured to detect when the incoming call has disconnected, the second opto coupler configured to detect when the incoming phone call is received.

23. The telephone call holding system of claim 18 further comprising a second line in jack accessible through the housing usable to connect the circuit to a second outside phone line.

24. The telephone call holding system of claim 18 further comprising a second line out jack accessible through the housing usable to connect the circuit to a second telephone.

25. The telephone call holding system of claim 19 wherein the microcontroller is further programmed to play music received through the audio jack to the while the caller is on hold.

26. The telephone call holding system of claim 18 wherein the circuit further comprises an audio device capable of recording an incoming message.

27. The telephone call holding system of claim 18 wherein the microcontroller is further programmed to play an audible tone periodically when a caller is on hold, indicating that a caller is holding.

28. The telephone call holding system of claim 18 wherein the microcontroller is further programmed to:
play a recorded message stored on the audio device providing the caller a choice to hold or leave a message on the audio device;
recording a message from the caller on the audio device if the caller chose to leave a message.

29. The telephone call holding system of claim 28 wherein the microcontroller is further programmed to play an audible tone periodically when a caller is on hold, indicating that a caller is holding.
